(19) United States
(12) Patent Application Publication
(10) Pub. No.: US 2015/0172252 A1
(43) Pub. Date: Jun. 18, 2015

(54) VISUAL REPRESENTATION OF COMPLEX NETWORK ADDRESS TRANSLATION RULES

(71) Applicant: Cisco Technology, Inc., San Jose, CA (US)

(72) Inventors: Subadevi PANDIAN, San Jose, CA (US); Vijayalakshmi PRABHAKARA, San Jose, CA (US); Shalini Kamalapuram SUNDARAM, San Jose, CA (US); Uzzal BARUAH, San Jose, CA (US)

(21) Appl. No.: 14/133,426

(22) Filed: Dec. 18, 2013

(51) Int. Cl. H04L 29/12; H04L 12/26

(52) U.S. Cl. CPC H04L 61/2571; H04L 43/045

(57) ABSTRACT

A method comprises receiving, from an internetworking security device, configuration data comprising a plurality of network address translation (NAT) statements, wherein one or more of the NAT statements reference one or more object-groups or nested object-groups; using a computing device, reading each of object groups in the configuration data and creating and storing a first table in memory, the first table comprising one or more first table entries each corresponding to one of the object-groups and parameter values of the object-groups; using the computing device, creating and storing a second table in the memory, the second table comprising one or more second table entries, wherein each of the second table entries corresponds to one of the NAT statements, and including resolving each of the object-groups into one or more corresponding second table entries; using the computing device, generating and causing displaying a visual representation or presentation that includes, for each of the NAT statements, each network address that is directly or indirectly represented in that NAT statement.

### FIELD OF THE DISCLOSURE

The present disclosure generally relates to computer network management. The disclosure relates more specifically to techniques for viewing and analyzing network address translation rules or commands.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Network address translation (NAT) is a process in computer networking of modifying network addresses, such as internet protocol (IP) addresses, while packets are in transit across a traffic routing devices; examples of such devices include routers, switches, and firewalls. General information about NAT and related techniques such as port address translation (PAT) is provided in Request for Comments (RFC) 2663 of the Internet Engineering Task Force.

Specific instructions about how a router should translate an address of an incoming packet often are stated in NAT rules that identify an original address and a translated address. The rules are expressed in command line interface (CLI) commands that are understandable by the router. The following policy static NAT example shows a single real address that is translated to two mapped addresses depending on the destination address:
hostname(config)# access-list NET1 permit ip host 10.1.2.27 209.165.201.0 255.255.255.224
hostname(config)# access-list NET2 permit ip host 10.1.2.27 209.165.200.224 255.255.255.224
hostname(config)# static (inside,outside) 209.165.202.129 access-list NET1
hostname(config)# static (inside,outside) 209.165.202.130 access-list NET2

In complex networks that include a large number of computers or other hosts, each having a different address, each router may be configured with dozens, hundreds or thousands of the NAT rules. For a human network administrator or other user, comprehending, managing, and modifying the rules rapidly becomes difficult.

The syntax of some CLI permits defining NAT rules in terms of objects representing ranges of addresses, subnets, or other abstractions. An object-group can contain or represent literal values, and/or a set or range of network addresses such as IP addresses, literal port values and/or a set or range of port numbers, a set of subnets, as well as other objects. When these objects or object-groups are used in a large number of NAT rules, a user may have difficulty determining the precedence, scope and coverage of the rules. For example, the NAT rules may be expressed in several levels of nested object groups; object group A could contain object group B, which in turn contains object group C. Such a configuration could involve complex, recursive object-groups that are not easily understood as particular IP addresses.

Object groups also may have varying types, based on but not limited to network attributes, protocol attributes, security attributes, service attributes or user attributes. Further, a first NAT rule might specify a narrow policy for a range of addresses, and a second NAT rule might specify a broader policy for a particular address that is within the range. If the first NAT rule and second NAT rules are separated in a configuration file by hundreds of other rules, then the user may have extreme difficulty comprehending that the rules are inconsistent, or that one rule is superfluous. Alternatively, a single host may be implicitly within the scope of multiple NAT statements. For example, NAT statement 1 may reference object A, containing host 10.10.10.10, and NAT statement 2 may identify Object B containing subnet 10.0.0.0/8. The user cannot easily predict which NAT statements will be applied for a given host. Eliminating superseded, ineffective or erroneous rules becomes a serious problem. Thus, there is a need for improved techniques to visualize the relationship of large numbers of NAT rules in networking devices.

### BRIEF DESCRIPTION OF THE DRAWINGS

In the drawings:

FIG. 1 illustrates a computer system configured to create a visual representation of network address translation (NAT) rules;

FIG. 2 illustrates a process of creating a visual representation of network address translation (NAT) rules;

FIG. 3 illustrates an example visualization that may be created using an embodiment;

FIG. 4 illustrates a computer system with which an embodiment may be implemented.

### DETAILED DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

In one embodiment, a data processing method comprises receiving, from an internetworking security device, configuration data comprising a plurality of network address translation (NAT) statements, wherein one or more of the NAT statements reference one or more object-groups or nested object-groups; using a computing device, reading each of the object groups and creating and storing a first table in memory of object group entries, the first table comprising one or more first table entries each corresponding to one of the object-groups and parameter values of the object-groups; using the computing device, creating and storing a second table in the memory, the second table comprising one or more second table entries, wherein each of the second table entries corresponds to an individual NAT statement, and including resolving each of the object-groups into one or more corresponding second table entries; using the computing device, generating and causing displaying a visual representation that includes, for each of the NAT statements, each network address that is directly or indirectly represented in that NAT statement.

In one embodiment, a computer system comprises one or more processors; one or more non-transitory computer storage media coupled to the one or more processors and comprising one or more sequences of instructions which, when executed by the one or more processors, cause performing: receiving, from an internetworking security device, configuration data comprising a plurality of network address translation (NAT) statements, wherein one or more of the NAT statements reference one or more object-groups and/or nested object-groups; using the computer system, reading each of the object groups and creating and storing a first table in memory of object group entries, the first table comprising one or more first table entries each corresponding to one of the object-groups and parameter values of the object-groups; using the computer system, creating and storing a second table in the memory, the second table comprising one or more second table entries, wherein each of the second table entries corresponds to an individual NAT statement, and including resolving each of the object-groups into one or more corresponding second table entries; using the computer system, generating and causing displaying a visual representation that includes, for each of the NAT statements, each network address that is directly or indirectly represented in that NAT statement.

### Structural and Functional Examples

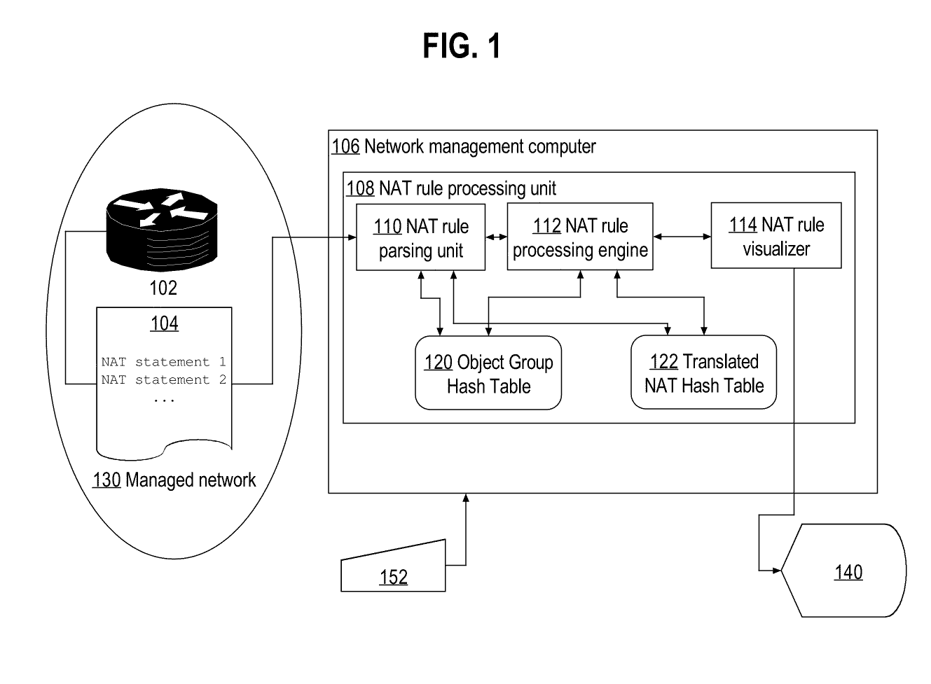

In various embodiments, a method and apparatus for parsing complex NAT rules and creating a visual representation of the rules is provided. FIG. 1 illustrates a computer system configured to create a visual representation of network address translation (NAT) rules, in one embodiment. A data packet router 102 having a configuration file 104 is within a managed network 130 that may comprise any number of other routers, switches, and other internetworking elements, as well as endpoint stations such as computers, printers, scanners, and other computing devices. For purposes of illustrating a clear example, FIG. 1 shows a single router 102, but other embodiments may interoperate with any number of networking devices in a managed network or unmanaged network. Router 102 may be configured as a security device such as a firewall at an edge of the managed network 130. Further, in this disclosure the term “configuration file” is used broadly to refer to configuration data in any useful stored format and the use of a file in a filesystem is not required. For example, configuration data may comprise a stored plurality of key-value pairs in database, directory, repository or data store other than a filesystem.

A network management computer 106 is coupled to the managed network 130. Network management computer 106 comprises a NAT rule processing unit 108, and may be coupled to one or more user input devices 152 and a computer display device 140 on which a graphical user interface (GUI) is rendered. Network management computer 106 typically comprises a server-class computer in a data center, but may be implemented using other computing devices such as a desktop computer or workstation, laptop computer, tablet computer, an instance in a virtualized environment of a cloud service provider, etc.

User input device 152 broadly represents any one or more of a keyboard, mouse, trackball, touchpad or touch-sensitive display, or any other device that may provide user input to a computer. Computer display device 140 may be an LCD display, LED display, touch-sensitive display, or any other device that may provide visible output from a computer.

NAT rule processing unit 108 comprises one or more computer programs, other software elements, hardware or firmware logic, or a combination thereof, to provide functional elements that cooperate to implement the processes and functions that are further described herein. In an embodiment, NAT rule processing unit 108 comprises a NAT rule parsing unit 110, NAT rule processing engine 112, NAT rule visualizer 114, Object Group Hash Table 120, and Translated NAT Hash Table 122. In an embodiment, NAT rule parsing unit 110 is configured to receive as input a device configuration file 104 from a security device such as router 102 or another element such as a firewall in which NAT rules or statements are defined, and the NAT rule parsing unit is coupled to the Object Group Hash Table 120 and to the Translated NAT Hash Table 122. In an embodiment, the NAT rule processing engine 112 is coupled to the NAT rule parsing unit 110, Object Group Hash Table 120 and to the Translated NAT Hash Table 122. In an embodiment, the NAT rule visualizer 114 is coupled to the NAT rule processing engine 112, and causes forming HTML documents, graphics or other elements that can drive or cause displaying information on computer display device 140. In this context, for purposes of illustrating a clear example, tables are identified as data structures, but any kind of data structures can be used in other embodiments.

In an embodiment, the Object Group Hash Table 120 and to the Translated NAT Hash Table 122 may be within a data repository such as a relational database, object store, flat file system, directory, memory, disk storage, or other form of data storage that is coupled to the NAT rule processing unit 108. In some embodiments, the Object Group Hash Table 120 and to the Translated NAT Hash Table 122 may be configured within a database that is optionally shared with other systems and stores other information such as inventory data relating to devices in managed network 130.

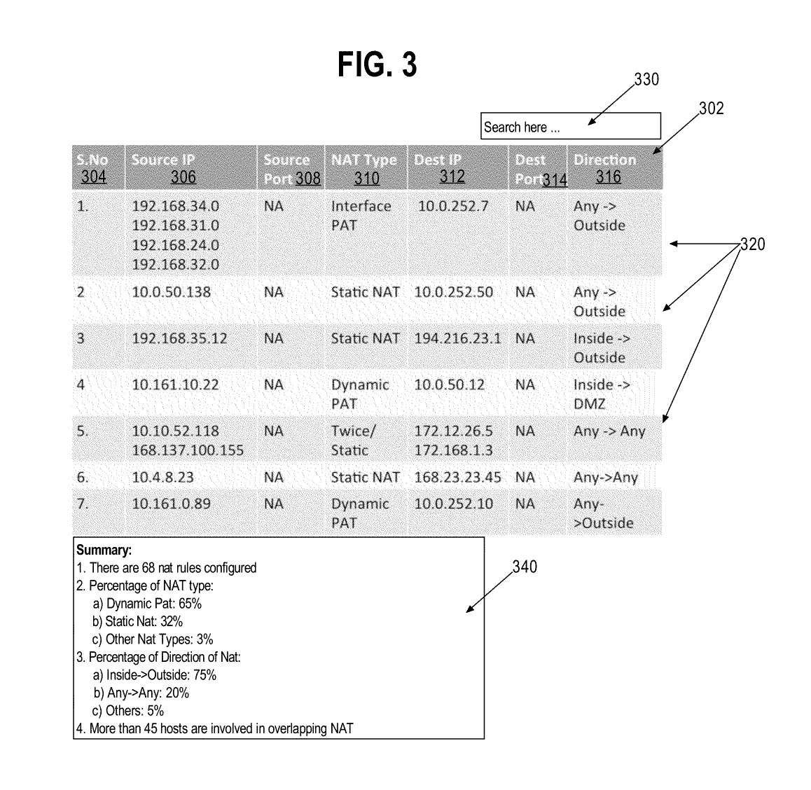

In an embodiment, in general, the NAT rule parsing unit 110 is configured to read and extract object groups and NAT rules from the security device configuration file 104. The NAT rule processing engine 112 is configured to traverse through one or more nested objects expressed in the configuration file 104 to create a simplified NAT rule structure in Object Group Hash Table 120. The NAT rule visualizer 114 is configured to convert the NAT rule structure into data tables, reports and other information that is output to display device 140. In some embodiments, searching may be performed based on parameters including but not limited to IP address, port, type of NAT, and direction of translation. The information output to display device 140 may provide a visual representation giving a summary of the NAT deployment as further described herein in connection with FIG. 3.

In an embodiment, the NAT rule parsing unit 110 is configured to traverse the configuration file 104 and perform two major processing steps. As one step, the NAT rule parsing unit 110 extracts all object groups specified in the configuration file 104, and creates and stores entries in Object Group Hash Table 120. Each entry includes, for each object group, a name and the parameters that are associated with the object group in the configuration file. For example, when a particular named nested object-group comprises a plurality of IP addresses, an entry in the Object Group Hash Table 120 would include the name of the object-group and a list of each of the addresses in the plurality of IP addresses, and a name of another object group. Consequently, the Object Group Hash Table 120 flattens each object-group defined in a configuration file and enables rapid access in later processing to the object-group name and parameter values.

In an embodiment, the Object Group Hash Table 120 may include a key value for each entry to permit rapid indexing and searching; the key value may be a hash over the object-group name.

As another step, the NAT rule parsing unit 110 extracts the NAT rules from the configuration file and populates the Translated NAT Hash Table 122 with values indicating, for all network elements referenced in a particular NAT statement, a source, translated address, type and direction. To update the type field in the Translated NAT Hash Table 122, the NAT rule parsing unit 110 compares each NAT statement of the configuration file 104 with a plurality of pre-defined or specified NAT statement patterns to identify the type of the NAT statement. Example types include static NAT/PAT, dynamic NAT/PAT, interface PAT, policy NAT, twice NAT, identity NAT.

In an embodiment, the NAT rule processing engine 112 is configured to perform two principal tasks. As one task, in an embodiment, the NAT rule processing engine 112 is configured to resolve a nested object group into an IP address or port, if any, and to populate the Translated NAT Hash Table 122 with data describing the group. As another task, in an embodiment, the NAT rule processing engine 112 is configured to provide a user interface that can receive and execute requests to search and filter the table, via GUI 142.

In an embodiment, the Translated NAT Hash Table 122 comprises a source IP address value, source port value, mapped IP address value, mapped port value parameters, and direction for every address translation that is defined on the security device. Thus, each entry in the table corresponds to at least one NAT statement in the configuration file 104, and an individual NAT statement in the configuration file may correspond to a plurality of entries in the table. To populate the table, the NAT rule processing engine 112 iterates through each entry in the Translated NAT Hash Table 122. If the entry identifies an IP or port value parameter, then the value is retained. If the entry corresponds to an object group, then the object group is resolved by performing a single or recursive lookup on the Object Group Hash Table 120.

For example, when a particular NAT statement refers to a non-nested object-group, then a single lookup operation in the Object Group Hash Table 120, based on the object-group name or a hashed key value, may be sufficient to obtain all individual network addresses, port values, or subnets that the object-group represents. However, if a first-lookup in the Object Group Hash Table 120 yields a second object-group as one of the parameter values for a first object-group, then a recursive call is performed into the same code base to cause a second lookup in the Object Group Hash Table to obtain flattened parameter values for the second object-group. If one of those parameter values is another object-group reference, then another call is performed until all calls result in returning discrete lists of addresses, port values, or subnets.

The lookups permit transforming object-group references in NAT statements into atomic values, such as IP address or port parameters, so that the NAT rule processing engine 112 may form an entry in the Translated NAT Hash Table 122 corresponding to the NAT statement with all the resolved source and destination parameters. As a result, the Translated NAT Hash Table 122 becomes populated or stored with a plurality of entries in which all abstract references to addresses or ports in the original NAT statements have been replaced with discrete values that can be used in subsequent visualization operations.

In an embodiment, the Translated NAT Hash Table 122 may include a key value for each entry to permit rapid indexing and searching; the key value may be a hash over a subset of all parameter values in a particular entry, or a hash over a first network address value represented in an entry.

In an embodiment, the NAT rule processing engine 112 is configured to provide search and filter functions that accept source parameter, mapped parameter, type, direction or combination of these as input. To parse the IP addresses, regular expression and bitwise operations are performed to look up values in the Translated NAT Hash Table 122 and match the values against subnets, ranges of IP addresses and host values. A regular expression matching operation is performed to parse all other parameters in the Translated NAT Hash Table 122. All matched entries are returned to the NAT rule visualizer 114.

In an embodiment, the NAT rule visualizer 114 is configured to generate a graphical user interface to display to facilitate user review of the NAT translations and to facilitate search functionality. The NAT rule visualizer 114 may be configured to extract data from the Translated NAT Hash Table 122 and to cause displaying the data in a table layout. In an embodiment, the table layout organizes the data into NAT parameters such as NAT type, source IP address, source port, mapped IP address, mapped port, and direction in which NAT is applied. These parameters typically represent the greatest interest for users; however, in other embodiments, other columns or organizational methods may be used.

In an embodiment, the NAT rule visualizer 114 is configured to provide a search and filter mechanism with which users may retrieve data relating to one or more NAT flows based on any of the NAT parameters or a combination thereof. In an embodiment, the search and filter mechanism also enables the user to easily identify overlapping NAT statements. For example, if the administrator performs a search on host 10.10.10.3, the search would list all possible NAT translations associated with the IP including NAT statements that are configured with subnet 10.0.0.0/8, or the range 10.10.1.1 to 10.10.10.5. User can also filter translations based on a service name, such as HTTP, and all matching entries of HTTP and corresponding port entries will be retrieved.

In an embodiment, the NAT rule visualizer 114 is configured to display a short summary of the NAT configuration. The summary contains but is not limited to: percentage of different types of NAT, direction of flow for easier debugging.

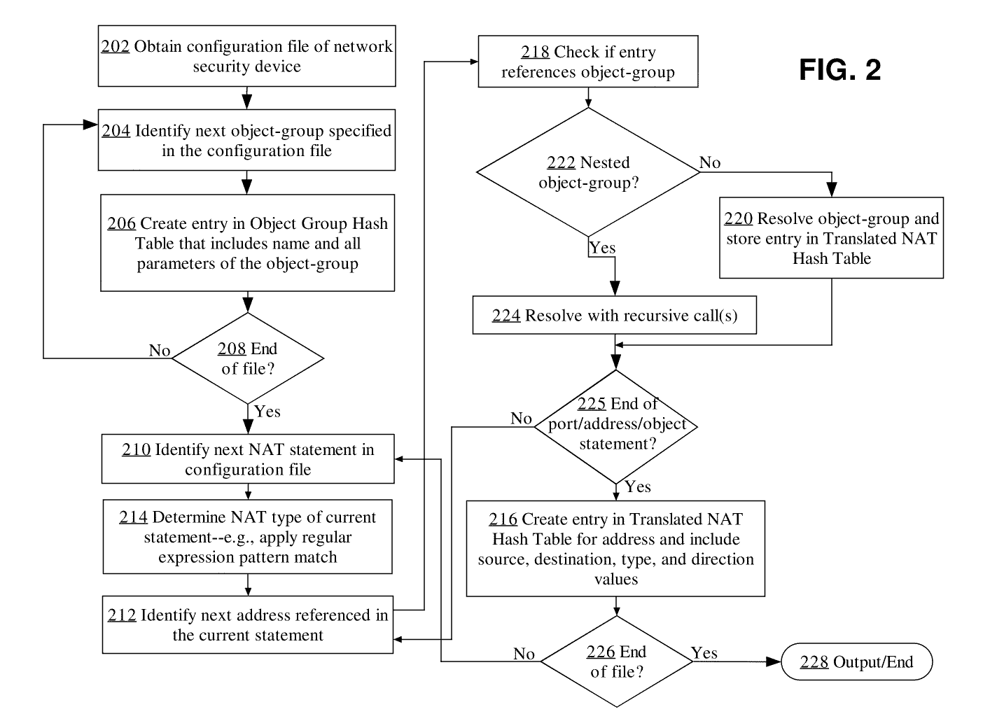

FIG. 2 illustrates a process of creating a visual representation of network address translation (NAT) rules, according to one embodiment. For purposes of illustrating a clear example, FIG. 2 is described herein in the context of FIG. 1, but other embodiments may be implemented in other contexts.

At block 202, the process obtains a configuration file of a network security device. For example, in one embodiment, NAT rule parsing unit 110 (FIG. 1) receives the configuration file 104 from router 102, which is configured as a firewall or other network security device.

At block 204, the process identifies the next object-group that is specified in the configuration file. In discussing other blocks of FIG. 2, the next object-group identified at block 204 may be termed the “current object-group” for purposes of processing in the other blocks.

At block 206, the process creates an entry in the Object Group Hash Table 120 that includes the name and all parameters of the current object-group. Block 208 tests whether the process has reached an end of the configuration file 104. If not, then control returns to block 204 to identify the next object-group in the file. The loop represented by block 204, 206, 208 continues until the entire configuration file 104 is processed and all object-groups have been entered in the hash table. As a result, the Object Group Hash Table contains entries for all object-groups that are specified in the configuration file 104.

At block 210, the process identifies the next NAT statement in the configuration file. For example, block 210 may be implemented using NAT rule parsing unit 110 to re-process the configuration file 104 on the basis of NAT statements or rules rather than object-groups in particular.

At block 214 the process determines the NAT type of the current statement. Block 214 may involve, in one embodiment, retrieving one or more stored regular expressions, or other data representing patterns that can be matched to rules or statements, and determining whether the expressions or data match the content of the current statement. If a match occurs, then a NAT type associated with the matching regular expression is used at the NAT type of the statement.

At block 212, the process identifies the next address, such as a source IP address or destination IP address, represented in the current NAT statement.

The process is configured to resolve all object-groups specified in the configuration file 104 into entries in the Translated NAT Hash Table, including flattening any nested object-groups that may be used in the configuration file. In an embodiment, at block 218, the process determines whether a particular entry in the Translated NAT Hash Table references an object-group. For example, NAT rule processing engine 112 scans the Translated NAT Hash Table and evaluates each entry in the table using the processes of block 220, block 222, block 224. At block 222, the process tests whether the current object-group references another object-group and thus represents a nested object-group. If so, then in block 224, the nested object-group is fully resolved via a series of one or more recursive calls to the same code that implements the process of blocks 218, 220, 222 as described herein.

If a nested object-group is not found, then control passes from block 222 to block 220, and the object-group is resolved into one or more individual address, port, or subnet entries as previously described with respect to FIG. 1. For example, if the object-group expresses a range of addresses, all addresses in the range are expanded and stored as individual entries in the Translated NAT Hash Table with corresponding values from the Object Group Hash Table.

Consequently, all nested object-groups expressed in NAT statements become flattened and represented as a plurality of discrete entries in the Translated NAT Hash Table without abstract object-group references in that table. For each object-group found in the NAT rules are also flattened in the object-group hash table so that if we encounter the same nested object group in other NAT rules, reprocessing of the same nested object-group is not required.

At block 225, the process tests whether the end of the current port or address or other object in the current statement has been reached. If not, control returns to block 212 to identify the next address and repeat the process starting at block 218. If the end of the statement has been reached, then at block 216, the process creates an entry in the Translated NAT Hash Table for the address that was identified at block 212, and includes other data associated with the current NAT statement such as source address, destination address, port, type, and direction values.

The process then reaches block 226 at which the process tests whether the end of the configuration file 104 has been reached. If not, then control transfers to block 210 where processing continues for other NAT statements that may be in the configuration file. If the end of the configuration file 104 has been reached, then at block 228 output may be provided, such as output in the form seen in FIG. 3, or the process may end or return to a calling process or another system. As a result, the Translated NAT Hash Table eventually contains a plurality of entries corresponding to all addresses that are referenced in the configuration file 104; each entry identifies a result object group for all elements of NAT.

FIG. 3 illustrates an example visualization that may be created using an embodiment. In an embodiment, a translated NAT data table 302 is organized using a plurality of columns 304, 306, 308, 310, 312, 314, 316 and rows 320. In an embodiment, the columns comprise a statement number column 304, a source address column 306, a source port column 308, a NAT type column 310, a destination address column 312, a destination port column 314, and a direction column 316. In an embodiment, each of the rows 320 corresponds to a particular NAT statement in the NAT configuration file 104 (FIG. 1). For each NAT statement, the statement number column 304 indicates an ordinal number of the statement; values in the column may increase monotonically and may correlate to successive NAT statements in the NAT configuration file 104 in the same order that the statements appear in the file. Alternatively, the order may be different.

In an embodiment, the source address column 306 indicates a source address that is mapped in the statement represented in the row 320. The source port column 308 indicates a source port value that is mapped in the statement. The NAT type column 310 indicates a type of NAT statement represented in the entry; in an embodiment, values in the NAT type column may be determined by mapping one or more regular expressions to the NAT statement extracted from the configuration file 104. The destination address column 312 indicates a value of a destination address that is mapped in the NAT statement represented in the row 320. The destination port column 314 indicates a destination port value that is mapped in the NAT statement. The direction column 316 indicates a direction of the NAT mapping that is represented in the statement.

A technical benefit of the data representation in the table 302 and the computer-implemented processes that produce the table is that the contents of the NAT configuration file 104 are greatly clarified and simplified for more rapid and natural user consumption. Complex NAT statements that refer to ranges of address values are decomposed so that each individual address represented in the statement may be seen. The NAT type of a statement, which may be difficult to parse from the statement in CLI format, is clearly indicated and readily consumed by the user, as is the direction of the mapping represented in the statement.

Table 302 may be presented in a graphical user interface that includes a search box 330 that is configured to receive user input specifying values to search for. In an embodiment, the search box 330 is configured to provide input search terms to the NAT rule processing engine 112, which is configured to search its database for matching values and present a filtered table view as the table 302. For example, user input in search box 330 could specify a particular address, NAT type, or port value and in response, the NAT rule processing engine would generate data sufficient to enable presenting a filtered view of table 302 that includes only rows with matching values. As a result, a user may rapidly obtain a view of specified NAT rules from among a configuration file 104 that may contain thousands of NAT rules.

The visualization of FIG. 3 may also include statistical data that is computed using NAT rule processing engine 112 based upon summing, aggregating, and/or performing percentage computations based upon the number of entries in the Translated NAT Hash Table having particular parameter values or types. For example, in one embodiment, the visualization of FIG. 3 also includes text output 340 having the following example format:

1. There are 68 NAT rules configured.

2. Percentage of NAT type: (a) Dynamic PAT: 65%; (b) Static NAT: 32%; (c) Other NAT Types: 3%.

3. Percentage of Direction of NAT: (a) Inside->Outside: 75%; (b) Any->Any: 20%; (c) Others: 5%.

4. More than 45 hosts are involved in overlapping NAT statements.

In these examples, particular numeric values for counts and percentages are hypothetical, and other embodiments may use other specific values depending upon the content of a configuration file. In an embodiment, item 1 may comprise a sum of all NAT statements that were found and processed in the configuration file 114.

In an embodiment, item 2 may comprise percentages that are determined by counting all statements that were processed and determined to have a particular NAT type at block 214 (FIG. 2), divided by all the configured NAT rules that were found.

In an embodiment, item 3 may comprise percentages that are determined by counting all statements that are represented in the Translated NAT Hash Table having a particular direction value, divided by all the configured NAT rules that were found.

In an embodiment, item 4 may comprise a count of all network addresses that appear in more than one NAT statement as determined by finding all instances of those addresses in the Translated NAT Hash Table 122. In other words, because the Translated NAT Hash Table 122 represents a flattening of indirect references to addresses in object-groups or nested object-groups, it is possible to identify all NAT statements in which a particular address is covered or affected even when that address is within a range or set of addresses that an abstract object-group represents. For example, logic implemented as part of NAT rule visualizer 114 may be configured to determine when a particular network address is represented in the Translated NAT Hash Table 122 two or more times and, in response, to increment a count of the number of hosts that are involved in overlapping NAT statements.

For purposes of display, large ranges of IP addresses that are represented discretely in the Translated NAT Hash Table 122 may be collapsed into ranges for purposes of better presentation. In an embodiment, the order of the NAT statements shown in FIG. 3 is determined according to a plurality of NAT precedence rules that are implemented by a NAT engine that governs prioritizing and enforcing NAT rules. The NAT engine implementing the precedence rules may be implemented using logic in network management computer 106 or another system. Integration of the NAT rule processing unit 108 with the precedence rules provides the distinct benefit that the user sees the NAT statements displayed in the visualizations of FIG. 3 in the order that they will be actually applied in enforcement, rather than the order in which they appear in the configuration file 104, which may be a different order than enforcement order. Examples include manual NAT and auto NAT where manual NAT is given precedence over auto NAT; other different types may be given a different precedence. For example, in some embodiments static NAT rules are given preference over dynamic NAT rules. Thus, different precedence rules may apply to different configuration data.

Based on the foregoing, it will be apparent that embodiments provide numerous benefits and have numerous technical effects. For example, the operation of network routing devices may be made faster and more efficient by removing duplicative or superfluous NAT statements after analysis of the NAT statements using embodiments. Further, the operation of the computer is made more efficient by the presentation of more compact, concise data representing a large number of NAT rules that have been configured; that is, there is no requirement to display each and every one of thousands of NAT statements. Instead, an aggregated and summarized display may represent multiple NAT statements in terms of mappings and without the need to display complex nested object relationships. The operation of the computer also becomes more efficient through the use of the searching and filtering functions of embodiments, as these functions enable the presentation of less data on the display device and the rapid retrieval of only those NAT statements that are relevant to a particular user.

Other benefits accrue to the user. For example, security devices in medium to large enterprises often have a large set of NAT rules, and reading through the configuration and understanding the NAT deployment is difficult. The visual representation of a NAT that is possible through the embodiments disclosed herein helps an administrator to read and comprehend the NAT rules. Further, understanding the one-to-one correlation between source parameters and mapped parameters may be complex when nested object structures are used. With embodiments, the administrator can rapidly find correlations between source and mapped parameters, aiding in analysis and troubleshooting. Embodiments will be useful to network administrators who are involved in troubleshooting large NAT translation rules, and users who analyze the translations and types of NAT that are implemented in security devices.

### Implementation Example

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

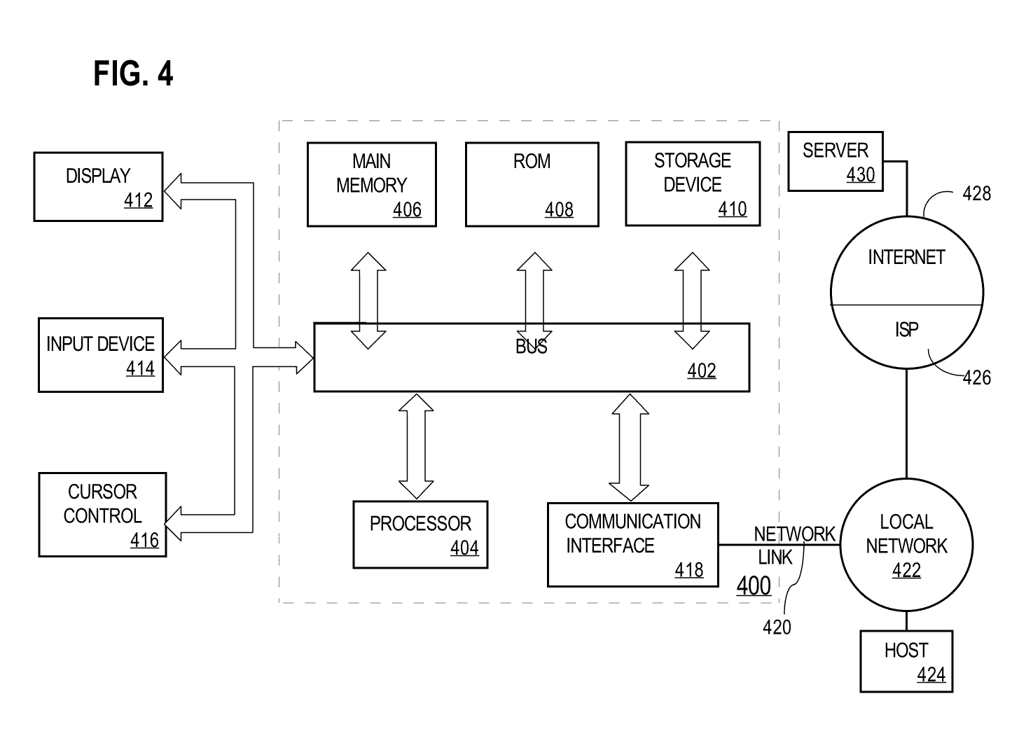

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, from an internetworking security device, configuration data comprising a plurality of network address translation (NAT) statements, wherein one or more of the NAT statements reference one or more object-groups and/or nested object-groups;
using a computing device, reading each object group in the configuration data and creating and storing a first table in memory, the first table comprising one or more first table entries each corresponding to one of the object-groups and parameter values of the object-groups;
using the computing device, creating and storing a second table in the memory, the second table comprising one or more second table entries, wherein each of the second table entries corresponds to one of the NAT statements, and including resolving each of the object-groups into one or more corresponding second table entries;
using the computing device, generating and causing displaying a visual representation that includes, for each of the NAT statements, each network address that is directly or indirectly represented in that NAT statement.

2. The method of claim 1, further comprising recursively resolving each of the nested object-groups into a further one or more corresponding second table entries.

3. The method of claim 1, further comprising:
identifying, in a particular NAT statement, a particular object-group;
obtaining, from the first table, a particular first table entry that represents the particular object-group;
obtaining, from the particular first table entry, each particular network address that is contained in the particular object-group;
creating and storing, in the second table, a particular second table entry for each particular NAT statement.

4. The method of claim 3, further comprising recursively repeating the obtaining operations recited in claim 3 in response to identifying, from the particular first table entry, a reference to another object-group that is contained in the particular object-group.

5. The method of claim 1, wherein all of the NAT statements do not expressly include a type of NAT that is expressed in the statements; comprising determining a NAT type of each of the NAT statements; generating and displaying, in the visual representation, the NAT type of each of the NAT statements represented in the visual representation.

6. The method of claim 5 wherein determining the NAT type of each of the NAT statements comprises using a plurality of stored regular expressions to match against the NAT statements.

7. The method of claim 1, further comprising generating and displaying the visual representation and including, for each of the NAT statements, each port value that is directly or indirectly represented in the NAT statements in the visual representation.

8. The method of claim 1, further comprising generating and displaying the visual representation and including, for each of the NAT statements, each direction value that is directly or indirectly represented in the NAT statements in the visual representation.

9. The method of claim 1 wherein the NAT statements comprise any of network address translation rules, port address translation rules, or network address and port translation rules.

10. A computer system comprising:
one or more processors;
one or more non-transitory computer storage media coupled to the one or more processors and comprising one or more sequences of instructions which, when executed by the one or more processors, cause performing:
receiving, from an internetworking security device, configuration data comprising a plurality of network address translation (NAT) statements, wherein one or more of the NAT statements reference one or more object-groups and/or nested object-groups;
using the computer system, reading each of the object groups in the configuration data and creating and storing a first table in memory, the first table comprising one or more first table entries each corresponding to one of the object-groups and parameter values of the object-groups;
using the computer system, creating and storing a second table in the memory, the second table comprising one or more second table entries, wherein each of the second table entries corresponds to one of the NAT statements, and including resolving each of the object-groups into one or more corresponding second table entries;
using the computer system, generating and causing displaying a visual representation that includes, for each of the NAT statements, each network address that is directly or indirectly represented in that NAT statement.

11. The computer system of claim 10, comprising sequences of instructions which when executed cause recursively resolving each of the nested object-groups into a further one or more corresponding second table entries.

12. The computer system of claim 10, comprising sequences of instructions which when executed cause:
identifying, in a particular NAT statement, a particular object-group;
obtaining, from the first table, a particular first table entry that represents the particular object-group;
obtaining, from the particular first table entry, each particular network address that is contained in the particular object-group;
creating and storing, in the second table, a particular second table entry for each particular NAT statement.

13. The computer system of claim 12, comprising sequences of instructions which when executed cause, further comprising recursively repeating the operations recited in claim 12 in response to obtaining, from the particular first table entry, a reference to another object-group that is contained in the particular object-group.

14. The computer system of claim 10, wherein all of the NAT statements do not expressly include a type of NAT that is expressed in the statements; comprising sequences of instructions which when executed cause determining a NAT type of each of the NAT statements; generating and displaying, in the visual representation, the NAT type of each of the NAT statements represented in the visual representation.

15. The computer system of claim 14, comprising sequences of instructions which when executed cause determining the NAT type of each of the NAT statements comprises using a plurality of stored regular expressions to match against the NAT statements.

16. The computer system of claim 10, comprising sequences of instructions which when executed cause, further comprising generating and displaying the visual representation and including, for each of the NAT statements, each port value that is directly or indirectly represented in the NAT statements in the visual representation.

17. The computer system of claim 10, comprising sequences of instructions which when executed cause, further comprising generating and displaying the visual representation and including, for each of the NAT statements, each direction value that is directly or indirectly represented in the NAT statements in the visual representation.

18. The computer system of claim 10 wherein the NAT statements comprise any of network address translation rules, port address translation rules, or network address and port translation rules.
